(19) United States
(12) Patent Application Publication
(10) Pub. No.: US 2021/0362701 A1
(43) Pub. Date: Nov. 25, 2021

(54) ELECTRONIC DEVICE AND OPERATING METHOD OF ELECTRONIC DEVICE

(71) Applicant: LG Electronics Inc., Seoul (KR)

(72) Inventors: Hyeonju BAE, Seoul (KR); Sangyol YOON, Seoul (KR); Taekyung LEE, Seoul (KR)

(21) Appl. No.: 16/603,064

(22) PCT Filed: Jul. 4, 2019
(86) PCT No.: PCT/KR2019/008202

§ 371 Date: Oct. 4, 2019

(51) Int. Cl. B60W 10/18; B60W 60/00; B25J 11/00; B25J 9/16

(52) U.S. Cl. CPC B60W 10/18; B60W 60/00; B60W 2556/45; B25J 9/161; B25J 11/008

(57) ABSTRACT

The present invention relates to an operating method of an electronic device including the steps of: receiving, by at least one processor, a signal generated when a vehicle enters a predetermined area; receiving, by at least one processor, a parking request signal of the vehicle; and providing, by at least one processor, a wakeup signal of an interaction device to at least one of the vehicle or a robot interacting with the vehicle, wherein the interaction device is a device for performing cooperative control of the vehicle and the robot. The vehicle may be an autonomous vehicle. A server, an autonomous vehicle and a robot can exchange a signal thereamong using a 5G communication system. The server, the autonomous vehicle and the robot may be implemented using an artificial intelligence (AI). The server, the autonomous vehicle and the robot can produce augmented reality (AR) contents.

### TECHNICAL FIELD

The present invention relates to an electronic device and an operating method of the electronic device.

### BACKGROUND ART

A vehicle is an apparatus movable in a desired direction by a user seated therein. A representative example of such a vehicle is an automobile. An autonomous vehicle means a vehicle which can automatically travel without manipulation of a person.

Robots have been developed for industrial purposes and, as such, have partially taken part in factory automation.

Recently, fields to which robots are applied have been further expanded. As such, medical robots, aerospace robots, etc. have been developed. Home service robots usable in homes have also been developed. Among such robots, a robot, which is autonomously movable, is referred to as a “mobile robot”.

A vehicle and a mobile robot perform interaction with the user while coexisting in various spaces. In this case, there may be a possibility of occurrence of an accident due to interference among the vehicle, the user and the robot. It is necessary to provide a technology for controlling the vehicle and the robot to meet a given situation, taking into consideration various factors such as the state of the vehicle, the type of the user, the kind of the mobile robot, characteristics of a given space, vehicle congestion, etc.

### DISCLOSURE

### Technical Problem

Therefore, the present invention has been made in view of the above problems, and it is an object of the present invention to provide an electronic device capable of performing cooperative control between a vehicle and a robot while preventing interference between the vehicle and the robot.

It is another object of the present invention to provide an operating method of an electronic device capable of performing cooperative control between a vehicle and a robot while preventing interference between the vehicle and the robot.

Objects of the present invention are not limited to the above-described objects, and other objects of the present invention not yet described will be more clearly understood by those skilled in the art from the following detailed description.

### Technical Solution

In accordance with an aspect of the present invention, the above objects can be accomplished by the provision of an operating method of an electronic device including the steps of: receiving, by at least one processor, a signal generated when a vehicle enters a predetermined area; receiving, by at least one processor, a parking request signal of the vehicle; and providing, by at least one processor, a wakeup signal of an interaction device to at least one of the vehicle or a robot interacting with the vehicle, wherein the interaction device is a device for performing cooperative control of the vehicle and the robot.

In accordance with another aspect of the present invention, there is provided an electronic device including: at least one processor for receiving a signal generated when a vehicle enters a predetermined area, receiving a parking request signal of the vehicle, and providing a wakeup signal of an interaction device to at least one of the vehicle or a robot interacting with the vehicle, wherein the interaction device is a device for performing cooperative control of the vehicle and the robot.

Concrete matters of other embodiments will be apparent from the detailed description and the drawings.

### Advantageous Effects

In accordance with the present invention, one or more effects are provided as follows.

First, there is an effect of preventing occurrence of an accident caused by interference between a vehicle and a robot in a space where both the vehicle and the robot operate.

Second, there is an effect of enhancing user convenience by providing a continued service up to a final destination of the user through combination of a vehicle and a robot.

The effects of the present invention are not limited to the above-described effects and other effects which are not described herein may be derived by those skilled in the art from the following description of the embodiments of the disclosure.

### DESCRIPTION OF DRAWINGS

FIG. 1 is a view referred to for explanation of a system according to an embodiment of the present invention.

FIG. 2 is a control block diagram of a vehicle according to an embodiment of the present invention.

FIG. 3 is a control block diagram of a robot according to an embodiment of the present invention.

FIG. 4 is a control block diagram of an electronic device according to an embodiment of the present invention.

FIG. 5 is a flowchart of the electronic device according to an embodiment of the present invention.

FIGS. 6 to 11 are views referred to for explanation of operation of the electronic device according to an embodiment of the present invention.

### BEST MODE

Reference will now be made in detail to the exemplary embodiments of the present invention, examples of which are illustrated in the accompanying drawings. Identical or similar constituent elements will be designated by the same reference numeral even though they are depicted in different drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present invention will be more clearly understood from the accompanying drawings and should not be limited by the accompanying drawings, and it is to be appreciated that all changes, equivalents, and substitutes that do not depart from the spirit and technical scope of the present invention are encompassed in the present invention.

It will be understood that, although the terms “first”, “second”, “third” etc. may be used herein to describe various elements, these elements should not be limited by these terms. These terms are only used to distinguish one element from another element.

It will be understood that when an element is referred to as being “connected to” or “coupled to” another element, it may be directly connected or coupled to the other element, or intervening elements may be present. In contrast, when an element is referred to as being “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof.

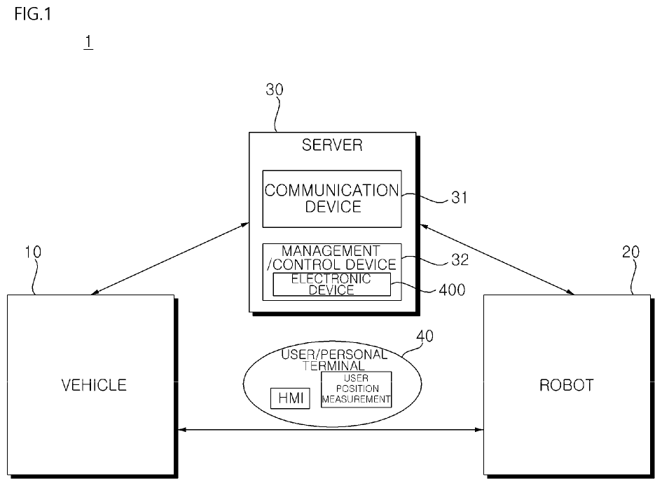

FIG. 1 is a view referred to for explanation of a system according to an embodiment of the present invention.

Referring to FIG. 1, the system 1 may include a vehicle 10, a robot 20, and a server 30. In accordance with an embodiment, the system 1 may further include a user terminal 40.

The vehicle 10 is defined as a transportation means to travel on a road or a railway line. The vehicle 10 is a concept including an automobile, a train, and a motorcycle. The vehicle 10 may be a concept including all of an internal combustion engine vehicle including an engine as a power source, a hybrid vehicle including an engine and an electric motor as a power source, an electric vehicle including an electric motor as a power source, etc. The vehicle 10 may be a shared vehicle. The vehicle 10 may be an autonomous vehicle. The vehicle 10 may communicate with at least one the robot 20, the server 30 or the user terminal 40 in a wireless manner.

The robot 20 is defined as a mechanical device substitute for labor of a person. The robot 20 may be a mobile robot. The robot 20 may communicate with at least one of the vehicle 10, the server 30 or the user terminal 40 in a wireless manner.

The server 30 may control operations of the vehicle 10 and the robot 20. The server 30 may include a communication device 31 and a management/control device 32. The communication device 31 may exchange a signal with the vehicle 10 and the robot 20. The management/control device 32 may produce data based on a signal, information or data received from at least one of the vehicle 10 or the robot 20 through the communication device 31. The management/control device 32 may provide data produced in at least one of the vehicle 10 or the robot 20 through the communication device 31. The server 30 may communicate with at least one of the vehicle 10, the robot 20 or the user terminal 40 in a wireless manner.

Communication among the vehicle 10, the robot 20, the server 30 and the user terminal 40 may be carried out using a 5G (for example, new radio (NR)) system.

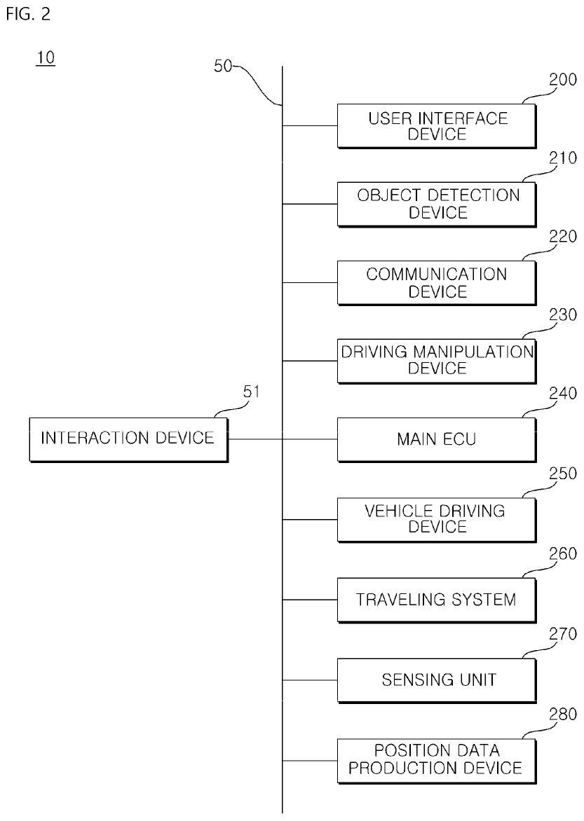

FIG. 2 is a control block diagram of the vehicle according to an embodiment of the present invention.

Referring to FIG. 2, the vehicle 10 may include an interaction device 51, a user interface device 200, an object detection device 210, a communication device 220, a driving manipulation device 230, a main electronic control unit (ECU) 240, a vehicle driving device 250, a traveling system 260, a sensing unit 270, and a position data production device 280.

The interaction device 51 may wake up from a sleep state based on a wakeup signal provided from the server 30. The interaction device 51 may be defined as a device for performing cooperative control between the vehicle 10 and the robot 20. The interaction device 51 may receive and process a signal, information or data from at least one of the robot 20, the server 30 or the user terminal 40. The interaction device 51 may convert the received signal, information or data into data having a format usable in the vehicle 10. The interaction device 51 may produce a signal, information or data to control the vehicle 10, based on the signal, information or data received from at least one of the robot 20, the server 30 or the user terminal 40. The interaction device 51 may provide a signal, information or data produced from the vehicle 10 to at least one of the robot 20, the server 30 or the user terminal 40.

The user interface device 200 is a device for enabling communication between the vehicle 10 and the user. The user interface device 200 may receive user input, and may provide information produced in the vehicle 10 to the user. The vehicle 10 may realize user interface (UI) or user experience (UX) through the user interface device 200.

The object detection device 210 may detect an object outside the vehicle 10. The object detection device 210 may include at least one sensor capable of detecting an object outside the vehicle 10. The object detection device 210 may include at least one of a camera, a radar, a lidar, an ultrasound sensor or an infrared sensor. The object detection device 210 may provide data as to an object produced based on a sensing signal generated in the sensor to at least one electronic device included in the vehicle.

The camera may produce information as to an object outside the vehicle 10, using an image. The camera may include at least one image sensor, and at least one processor electrically connected to the image sensor, to process a signal received from the image sensor and to produce data as to an object based on the processed signal.

The camera may be at least one of a mono camera, a stereo camera, or an around view monitoring (AVM) camera. Using various image processing algorithms, the camera may acquire position information of an object, information as to a distance from the object or information as to a relative speed with respect to the object. For example, the camera may acquire information as to a distance from an object and information as to a relative speed with respect to the object from an acquired image, based on a variation in the size of the object according to time. For example, the camera may acquire distance information and relative speed information associated with an object through a pin hole model, road surface profiling, etc. For example, the camera may acquire distance information and relative speed information associated with an object from a stereo image acquired in a stereo camera, based on disparity information.

In order to photograph an outside of the vehicle, the camera may be mounted at a position in the vehicle where the camera can secure a field of view (FOV). In order to acquire an image in front of the vehicle, the camera may be disposed in an inner compartment of the vehicle in the vicinity of a front windshield. The camera may be disposed around a front bumper or a radiator grill. In order to acquire an image in the rear of the vehicle, the camera may be disposed in the inner compartment of the vehicle in the vicinity of a rear glass. The camera may be disposed around a rear bumper, a trunk or a tail gate. In order to acquire an image at a lateral side of the vehicle, the camera may be disposed in the inner compartment of the vehicle in the vicinity of at least one of side windows. Alternatively, the camera may be disposed around a side mirror, a fender, or a door.

The radar may produce information as to an object outside the vehicle 10 using radio waves. The radar may include an electromagnetic wave transmitter, an electromagnetic wave receiver, and at least one processor electrically connected to the electromagnetic wave transmitter and the electromagnetic wave receiver, to process a received signal and to produce data as to an object based on the processed signal. The radar may be embodied through a pulse radar system or a continuous wave radar system based on a radio wave emission principle. The radar may be embodied through a frequency modulated continuous wave (FMCW) system or a frequency shift keyong (FSK) system selected from continuous wave radar systems in accordance with a signal waveform. The radar may detect an object, a position of the detected object, and a distance and a relative speed with respect to the detected object by means of an electromagnetic wave on the basis of time of flight (TOF) or phase shift. The radar may be disposed at an appropriate position outside the vehicle in order to sense an object disposed at a front, rear or lateral side of the vehicle.

The lidar may produce information as to an object outside the vehicle 10, using laser light. The lidar may include an optical transmitter, an optical receiver, and at least one processor electrically connected to the optical transmitter and the optical receiver, to process a received signal and to produce data as to an object based on the processed signal. The lidar may be embodied through a time-of-flight (TOF) system and a phase shift system. The lidar may be implemented in a driven manner or a non-driven manner. When the lidar is implemented in a driven manner, the lidar may detect an object around the vehicle 10 while being rotated by a motor. When the lidar is implemented in a non-driven manner, the lidar may detect an object disposed within a predetermined range with reference to the vehicle by optical steering. The vehicle 100 may include a plurality of non-driven lidars. The lidar may detect an object, a position of the detected object, and a distance and a relative speed with respect to the detected object by means of laser light on the basis of time of flight (TOF) or phase shift. The lidar may be disposed at an appropriate position outside the vehicle in order to sense an object disposed at a front, rear or lateral side of the vehicle.

The communication device 220 may exchange a signal with a device disposed outside the vehicle 10. The communication device 220 may exchange a signal with at least one of infrastructure (for example, a server or a broadcasting station) or another vehicle. The communication device 220 may include at least one of a transmission antenna, a reception antenna, a radio frequency (RF) circuit or an RF element capable of implementing various communication protocols in order to execute communication. The communication device 220 may exchange a signal, information or data with at least one of the robot 20, the server 30 or the user terminal 40.

The driving manipulation device 230 is a device for receiving user input for driving. In a manual mode, the vehicle 10 may be driven based on a signal provided by the driving manipulation device 230. The driving manipulation device 230 may include a steering input device (for example, a steering wheel), an acceleration input device (for example, an accelerator pedal), and a brake input device (for example, a brake pedal).

The main ECU 240 may control overall operation of at least one electronic device included in the vehicle 10.

The driving control device 250 is a device for electrically controlling various vehicle driving devices in the vehicle 10. The driving control device 250 may include a powertrain driving control device, a chassis driving control device, a door/window driving control device, a safety device driving control device, a lamp driving control device, and an air conditioner driving control device. The powertrain driving control device may include a power source driving control device and a transmission driving control device. The chassis driving control device may include a steering driving control device, a brake driving control device, and a suspension driving control device.

Meanwhile, the safety device driving control device may include a safety belt driving control device for safety belt control.

The vehicle driving control device 250 may be referred to as a “control electronic control unit (ECU)”.

The traveling system 260 may control motion of the vehicle 10 or may generate a signal for outputting information to the user, based on data as to an object received from the object detection device 210. The traveling system 260 may provide the generated signal to at least one of the user interface device 200, the main ECU 240 or the vehicle driving device 250.

The traveling system 260 may be a concept including an advanced driver-assistance system (ADAS). The ADAS 260 may embody an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind sport detection (BSD) system, an adaptive high beam assist (HBA) system, an auto-parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous travel path based on data received from at least one of other electronic devices in the vehicle 10. The autonomous ECU may set an autonomous travel path based on data received from at least one of the user interface device 200, the object detection device 210, the communication device 220, the sensing unit 270, or the position data production device 280. The autonomous traveling ECU may generate a control signal to enable the vehicle 10 to travel along the autonomous travel path. The control signal generated from the autonomous traveling ECU may be provided to at least one of the main ECU 240 or the vehicle driving device 250.

The sensing unit 270 may sense a state of the vehicle. The sensing unit 270 may include at least one of an inertial navigation unit (IMU) sensor, a collision sensor, a wheel sensor, a speed sensor, a slope sensor, a weight sensor, a heading sensor, a position module, a vehicle forward/backward movement sensor, a battery sensor, a fuel sensor, a tire sensor, a handle-rotation-based steering sensor, an internal vehicle temperature sensor, an internal vehicle humidity sensor, an ultrasonic sensor, an ambient light sensor, an accelerator pedal position sensor, or a brake pedal position sensor. Meanwhile, the inertial navigation unit (IMU) sensor may include at least one of an acceleration sensor, a gyro sensor, or a magnetic sensor.

The sensing unit 270 may produce vehicle state data based on a signal generated from at least one sensor. The sensing unit 270 may acquire sensing signals as to vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward movement information, battery information, fuel information, tire information, vehicle lamp information, internal vehicle temperature information, internal vehicle humidity information, a steering wheel rotation angle, ambient illumination outside the vehicle, a pressure applied to the accelerator pedal, a pressure applied to the brake pedal, etc.

In addition, the sensing unit 270 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), etc.

The sensing unit 270 may produce vehicle state information based on sensing data. The vehicle state information may be information produced based on data sensed by various sensors included in the vehicle.

For example, the vehicle state information may include vehicle posture information, vehicle speed information, vehicle inclination information, vehicle weight information, vehicle direction information, vehicle battery information, vehicle fuel information, vehicle tire air pressure information, vehicle steering information, internal vehicle temperature information, internal vehicle humidity information, pedal position information, vehicle engine temperature information, etc.

Meanwhile, the sensing unit may include a tension sensor. The tension sensor may generate a sensing signal based on a tension state of a safety belt.

The position data production device 280 may produce position data of the vehicle 10. The position data production device 280 may include at least one of a global positioning system (GPS) or a differential global positioning system (DGPS). The position data production device 280 may produce position data of the vehicle 10 based on a signal generated from at least one of the GPS or the DGPS. In accordance with an embodiment, the position data production device 280 may correct position data based on at least one of an internal measurement unit (IMU) of the sensing unit 270 or a camera of the object detection device 210.

The position data production device 280 may be referred to as a “position measurement device”. The position data production device 280 may be referred to as a “global navigation satellite system (GNSS)”.

The vehicle 10 may include an inner communication system 50. Plural electronic devices included in the vehicle 10 may exchange a signal via the inner communication system 50. Data may be included in the signal. The inner communication system 50 may utilize at least one communication protocol (for example, CAN, LIN, FlexRay, MOST, or Ethernet).

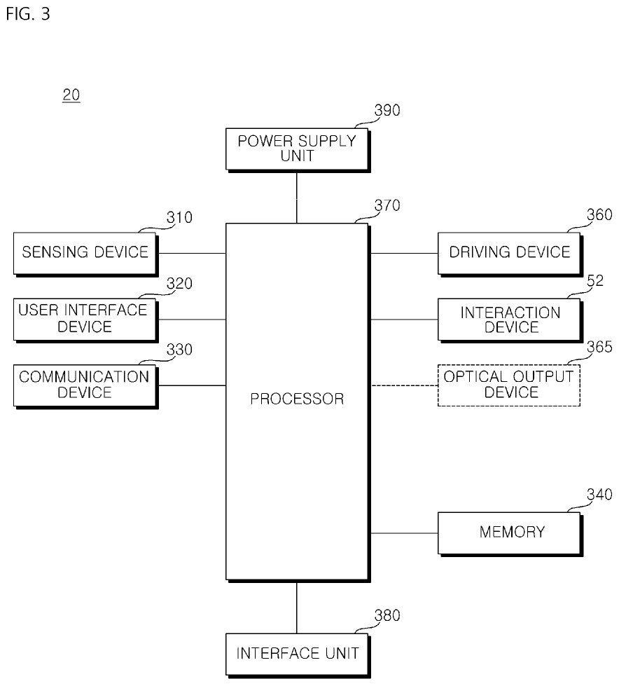

FIG. 3 is a control block diagram of the robot according to an embodiment of the present invention.

Referring to FIG. 3, the robot 20 may include a sensing device 310, a user interface device 320, a communication device 330, a driving device 360, an interaction device 52, a memory 340, a processor 370, an interface unit 380, and a power supply unit 390.

The sensing device 310 may acquire surrounding information of the robot 20. The sensing device 310 may include at least one of a camera, a radar, a lidar or an infrared sensor.

The user interface device 320 is a device for enabling communication between the robot 20 and the user. The user interface device 320 may receive user input, and may provide information produced in the robot 20 to the user. The robot 20 may realize user interface (UI) or user experience (UX) through the user interface device 320.

The communication device 330 may exchange a signal with a device disposed outside the vehicle 10. The communication device 330 may include at least one of a transmission antenna, a reception antenna, a radio frequency (RF) circuit or an RF element capable of implementing various communication protocols in order to execute communication. The communication device 330 may exchange a signal, information or data with at least one of the vehicle 10, the server 30 or the user terminal 40.

The driving device 360 may move a body of the robot 20 in accordance with a control signal generated from the processor 370. The driving device 360 may include a wheel or a leg for moving the body of the robot 20. The driving device 360 may include a driving control device for controlling the wheel or the leg.

The interaction device 52 may wake up from a sleep state based on a wakeup signal provided from the server 30. The interaction device 52 may be defined as a device for performing cooperative control between the vehicle 10 and the robot 20. The interaction device 52 may receive and process a signal, information or data from at least one of the vehicle 10, the server 30 or the user terminal 40. The interaction device 52 may convert the received signal, information or data into data having a format usable in the robot 20. The interaction device 52 may produce a signal, information or data to control the robot 20, based on the signal, information or data received from at least one of the vehicle 10, the server 30 or the user terminal 40. The interaction device 52 may provide a signal, information or data produced from the robot 20 to at least one of the vehicle 10, the server 30 or the user terminal 40.

The memory 340 is electrically connected to the processor 370. The memory 340 may store basic data as to units, control data for unit operation control, and input and output data. The memory 340 may store data processed by the processor 370. The memory 340 may be constituted in a hardware manner by at least one of a read only memory (ROM), a random access memory (RAM), an erasable programmable read-only memory (EPROM), a flash drive, or a hard drive. The memory 340 may store various data for overall operation of the electronic device 400 including a program for processing or controlling the processor 370, etc. The memory 340 may be embodied as an integrated type with the processor 370. In accordance with an embodiment, the memory 340 may be classified into a lower-level configuration of the processor 370.

The interface unit 380 may exchange a signal with at least one electronic device included in the robot 20 in a wired or wireless manner. The interface unit 280 may be constituted by at least one of a communication module, a terminal, a pin, a cable, a port, a circuit, an element, or a device.

The power supply unit 390 may supply electric power to the electronic device 400. The power supply unit 390 may receive electric power from a power source (for example, a battery) and, as such, may supply electric power to each unit.

The processor 370 may be electrically connected to the memory 340, the interface unit 280, and the power supply unit 390, and, as such, may exchange a signal therewith. The processor 370 may be embodied using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or electrical units for execution of other functions.

The processor 370 may be driven by electric power supplied from the power supply unit 390. In a state in which electric power from the power supply unit 390 is supplied to the processor 370, the processor 370 may receive data, process the data, generate a signal, and supply the signal.

The processor 370 may receive information from other electronic devices in the robot 20 via the interface unit 380. The processor 370 may supply a control signal to other electronic devices in the robot 20 via the interface unit 380.

The processor 370 may generate a control signal based on a signal, information or data received via the communication device 330. The processor 370 may generate a control signal based on a signal, information or data received via the interaction device 52. The processor 370 may provide the control signal to the user interface device 320, the driving device 360 and an optical output device 365.

The robot 20 may further include the optical output device 365. The optical output device 365 may include at least one light source. The optical output device 365 may generate light based on a control signal generated from the processor 370, and may output the generated light to the outside of the robot 20. The optical output device 365 may output guide light based on received data as to guide light. The optical output device 365 may output guide light to guide at least a portion of a section from a parking point of the vehicle to a destination of the user. The user may move on a pedestrian road along the guide light.

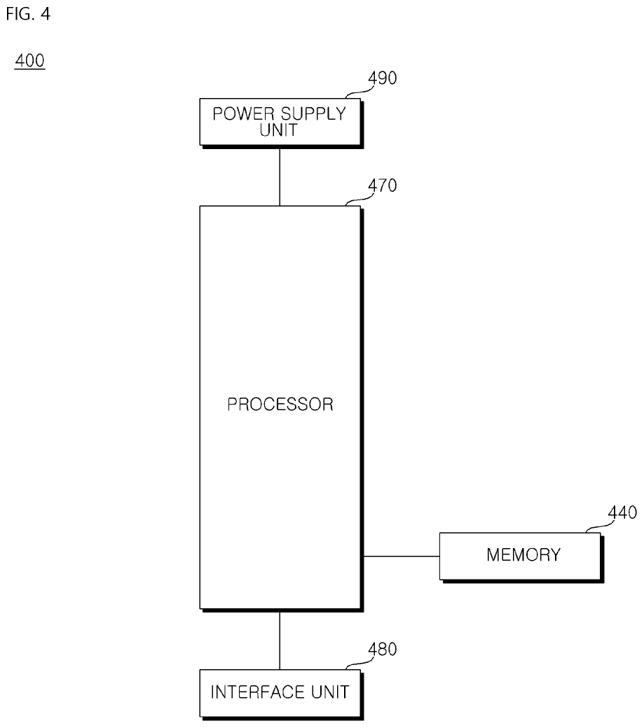

FIG. 4 is a control block diagram of the electronic device according to an embodiment of the present invention.

Referring to FIG. 4, the electronic device 400 may include a memory 440, a processor 470, an interface unit 480, and a power supply unit 490.

The memory 440 is electrically connected to the processor 470. The memory 440 may store basic data as to units, control data for unit operation control, and input and output data. The memory 440 may store data processed by the processor 470. The memory 440 may be constituted in a hardware manner by at least one of a read only memory (ROM), a random access memory (RAM), an erasable programmable read-only memory (EPROM), a flash drive, or a hard drive. The memory 440 may store various data for overall operation of the electronic device 400 including a program for processing or controlling the processor 470, etc. The memory 440 may be embodied as an integrated type with the processor 470. In accordance with an embodiment, the memory 440 may be classified into a lower-level configuration of the processor 470.

The interface unit 480 may exchange a signal with at least one electronic device included in the vehicle 10 in a wired or wireless manner. The interface unit 280 may exchange a signal in a wired or wireless manner with at least one of the object detection device 210, the communication device 220, the driving manipulation device 230, the main ECU 440, the vehicle driving device 250, the ADAS 260, the sensing unit 470, or the position data production device 280. The interface unit 280 may be constituted by at least one of a communication module, a terminal, a pin, a cable, a port, a circuit, an element, or a device.

The interface unit 480 may receive position data of the vehicle 10 from the position data production device 280. The interface unit 480 may receive travel speed data from the sensing unit 270. The interface unit 480 may receive vehicle surrounding object data from the object detection device 210.

The power supply unit 490 may supply electric power to the electronic device 400. The power supply unit 490 may receive electric power from a power source (for example, a battery) included in the vehicle 10 and, as such, may supply electric power to each unit of the electronic device 400. The power supply unit 490 may be embodied using a switched-mode power supply (SMPS).

The processor 470 may be electrically connected to the memory 440, the interface unit 280, and the power supply unit 490, and, as such, may exchange a signal therewith. The processor 470 may be embodied using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or electrical units for execution of other functions.

The processor 470 may be driven by electric power supplied from the power supply unit 490. In a state in which electric power from the power supply unit 490 is supplied to the processor 470, the processor 470 may receive data, process the data, generate a signal, and supply the signal.

The processor 470 may receive information from other electronic devices in the vehicle 10 via the interface unit 480. The processor 470 may supply a control signal to other electronic devices in the vehicle 10 via the interface unit 480.

The processor 470 may receive a signal via a communication device (“31” in FIG. 1). The processor 470 may receive a signal generated as the vehicle 10 enters a predetermined area. For example, the processor 470 may receive a signal from the vehicle 10. For example, the processor 470 may receive a signal from a management server for managing the predetermined area.

The processor 470 may receive a parking request signal of the vehicle 10. The processor 470 may receive a parking request signal from the processor 470. Meanwhile, in the present disclosure, parking is defined as stopping of the vehicle at a specific point for exit of the user. In the present disclosure, parking may also include a concept of standing.

The processor 470 may provide a wakeup signal for interaction devices 51 and 52 to at least one of the vehicle 10 or the robot 20 interacting with the vehicle 10. The vehicle 10 may include a first interaction device 51. The robot 20 may include a second interaction device 52. The interaction devices 51 and 52 may be explained as devices for performing cooperative control for the vehicle 10 and the robot 20. Upon receive a wakeup signal in a sleeping state, the interaction devices 51 and 52 may be driven. In accordance with a signal received from the electronic device 400, the interaction devices 51 and 52 may perform cooperative control between the vehicle 10 and the robot 20 while preventing interference between the vehicle 10 and the robot 20. The first interaction device 51 may convert a signal received from at least one of the robot 20, the server 30 or the user terminal 40 into data usable in the vehicle 10. The first interaction device 51 may convert data produced in the vehicle 10 into a signal to be transmitted to at least one of the robot 20, the server 30 or the user terminal 40. The second interaction device 52 may convert a signal received from at least one of the vehicle 10, the server 30 or the user terminal 40 into data usable in the robot 20. The second interaction device 52 may convert data produced in the robot 20 into a signal to be transmitted to at least one of the vehicle 10, the server 30 or the user terminal 40.

The processor 470 may receive situation information of the vehicle 10 from the vehicle 10. The situation information of the vehicle 10 may include at least one of path information of the vehicle, parking point information of the vehicle, destination information of the vehicle user, motion information of at least one moving part included in the vehicle, user information (information as to whether or not there is a pregnant woman, a mobility impaired person or a burden), or information as to whether the vehicle is an autonomous vehicle or a manual vehicle.

The processor 470 may provide data for interaction to at least one of the vehicle 10 or the robot 20 based on the situation information.

The situation information may include path information of the vehicle 10. The processor 470 may produce data as to a path of the robot prevented from overlapping with a path of the vehicle 10. The processor 470 may provide data as to the produced robot path.

The processor 470 may divide a predetermined area into a vehicle area and a robot area in accordance with congestion of the predetermined area. For example, when the congestion of the predetermined area is equal to or higher than a predetermined level, the processor 470 may divide the predetermined area into the vehicle area and the robot area. The vehicle area may be explained as an area where the vehicle 10 may travel, and the robot area may be explained as an area where the robot may move. The processor 470 may produce data as to a path of the robot 20 along which the robot 20 moves in the robot area without invading the vehicle area. The processor 470 may provide data as to a path of the robot 20.

The processor 470 may determine at least one point, at which the robot 20 is to be positioned, from the robot area. Here, the point may be explained as a point maximally close to a rear end of the vehicle 10 without interference in a parking completion state of the vehicle 10. The processor 470 may produce data as to a path passing through at least one point.

The situation information may include parking point information of the vehicle 10 and destination information of the user of the vehicle 10. The processor 470 may produce data as to guide light for guidance from a parking point to a destination. The processor 470 may provide the data as to the guide light to the robot 20. The light guide may be produced by the optical output device 365 of the robot 20. The light guide may be explained as a virtual pedestrian road for guiding the user from a parking point to a final destination of the user.

The processor 470 may receive sensing data of the robot 20. The processor 470 may receive sensing data produced in the sensing device 310 of the robot 20. For example, the processor 470 may receive sensing data as to the user produced in the sensing device 310. The user may be understood as the user of the vehicle 10 having exited the vehicle 10. The processor 470 may produce the data as to the guide light further based on the sensing data produced in the sensing device 310.

The situation information may include motion information of at least one moving part included in the vehicle 10. The moving part may be at least one of a door, a trunk, a tail gate or a window. The processor 470 may produce data as to motion of the robot 20 prevented from interfering with motion of the moving part of the vehicle 10. The processor 470 may provide the data as to the motion of the robot 20.

The situation information may include information as to the user of the vehicle 10. The information as to the user may include at least one of information as to a user type (for example, an elderly person, a pregnant woman, a disabled person) or information as to a burden occupied by the user. The processor 470 may allocate at least one robot matched with the vehicle 10 based on the information as to the user. For example, the processor 470 may allocate a first robot for guiding the user, and a second robot for carrying a burden while matching the first and second robots with the vehicle 10.

The situation information may include information as to whether or not the vehicle 10 is in a manually traveling state. The processor 470 may produce data for guiding a path of the vehicle 10 in a predetermined area. The processor 470 may provide the data for guiding the path of the vehicle 10 to the robot 20. The robot 20 may guide the path of the vehicle 10 in the predetermined area. The robot 20 may guide the path of the vehicle 10 through the optical output device 365. For example, the robot 20 may output a turn-by-turn (TBT) image through the optical output device 365 while moving in a state of preceding the vehicle 10.

The processor 470 may provide data as to an authentication operation of the vehicle 10 to the robot 20. The authentication operation of the vehicle 10 may include a wiper driving operation, and a turn-on/off operation of at least one lamp included in the vehicle 10. The robot 20 may perform authentication by comparing data received from the electronic device 400 with sensing data of operation of the vehicle 10.

The electronic device 400 may include at least one printed circuit board (PCB). The memory 440, the interface unit 480, the power supply unit 490 and the processor 470 may be electrically connected to the printed circuit board.

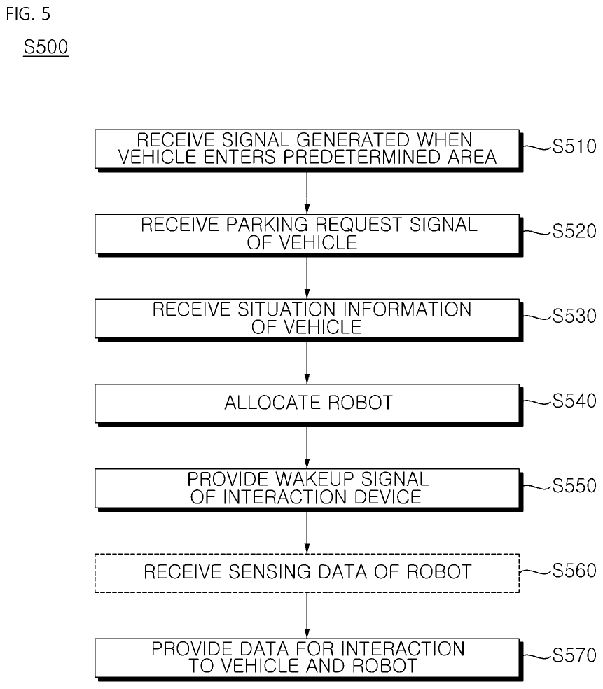

FIG. 5 is a flowchart of the electronic device according to an embodiment of the present invention.

Referring to FIG. 5, the processor 170 may receive a signal generated as the vehicle 10 enters a predetermined area (S510). When the vehicle 10 enters a predetermined area (for example, a parking place), a signal may be generated from the vehicle 10 or a management server in the predetermined area. The processor 470 may receive the generated signal via a communication device (“31” in FIG. 1).

The processor 170 may receive a parking request signal from the vehicle 10 (S520). Upon receiving the parking request signal from the vehicle 10, the processor 170 may provide, to the robot 20, data for guiding a path of the vehicle to an allocated parking slot. The robot 20 may guide a path of the vehicle 10 in a predetermined area. The robot 20 may guide a path of the vehicle 10 through the optical output device 365. For example, the robot 20 may output a turn-by-turn (TBT) image through the optical output device 365 while moving in a state of preceding the vehicle 10.

The processor 170 may receive situation information of the vehicle 10 (S530). The situation information of the vehicle 10 may include at least one of path information of the vehicle, parking point information of the vehicle, destination information of the vehicle user, motion information of at least one moving part included in the vehicle, user information (information as to whether or not there is a pregnant woman, a mobility impaired person or a burden), or information as to whether the vehicle is an autonomous vehicle or a manual vehicle.

The processor 170 may allocate the robot 20 based on the situation information of the vehicle 10 (S540). The situation information may include information of the user of the vehicle 10. The processor 170 may allocate at least one robot matched with the vehicle 10 based on the information as to the user. The information as to the user may include information as to a burden occupied by the user. The robot allocation step S540 may include a step of allocating a first robot for guiding the user, and a second robot for carrying a burden while matching the first and second robots with the vehicle 10.

The processor 170 may provide a wakeup signal of the interaction devices 51 and 52 to at least one of the vehicle 10 or the robot 20 interacting with the vehicle 10 (S550). The interaction devices 51 and 52 may be explained as devices for performing cooperative control for the vehicle 10 and the robot 20.

The processor 170 may receive sensing data of the robot 20 (S560). The processor 170 may receive data generated from the sensing device 310 of the robot 20. For example the processor 170 may receive user sensing data from the sensing device 310. Meanwhile, step S560 may be applied or may not be applied in a selective manner.

The processor 170 may provide data for interaction to at least one of the vehicle 10 or the robot 20 based on the situation information of the vehicle 10 (S570). The processor 170 may provide data for interaction to the interaction devices 51 and 52.

The situation information may include path information of the vehicle 10. The step S570 of providing data may include steps of producing, by at least one processor 170, data as to a path of the robot prevented from overlapping with a path of the vehicle 10, and providing, by at least one processor 170, data as to the path of the robot 20.

The step S570 of providing data may include steps of dividing, by at least one processor 170, a predetermined area into a vehicle area and a robot area in accordance with congestion of the predetermined area, producing, by at least one processor 170, data as to a path of the robot along which the robot moves in the robot area without invading the vehicle area, and providing, by at least one processor 170, data as to the path of the robot 20.

The step S570 of providing data may include a step of determining, by at least one processor 170, at least one point, at which the robot is to be positioned, from the robot area. The step of producing data as to the path of the robot may include a step of producing, by at least one processor 170, data as to a path passing through at least one point.

The situation information may include parking point information of the vehicle 10 and destination information of the user of the vehicle 10. The step S570 of providing data may include steps of producing, by at least one processor 170, data as to guide light for guidance from a parking point to a destination, and providing, by at least one processor 170, the data as to the guide light to the robot 20. Meanwhile, in the step of producing the data as to the guide light, at least one processor 170 may produce the data as to the guide light further based on sensing data received in step S560.

The situation information may include motion information of at least one moving part included in the vehicle 10. The step S570 of providing data may include steps of producing, by at least one processor 170, data as to motion of the robot 20 prevented from interfering with motion of the moving part, and providing the data as to the motion of the robot 20.

The situation information may include information as to whether or not the vehicle 10 is in a manually traveling state. The step S570 of providing data may include steps of producing, by at least one processor 170, data for guiding a path of the vehicle 10 in a predetermined area, and providing, by at least one processor 170, the data for guiding the path of the vehicle 10 to the robot 20.

The situation information may include information as to whether or not the vehicle 10 is in a manually traveling state. The step S570 of providing data may include a step of providing, by at least one processor 170, data as to an authentication operation of the vehicle 10 to the robot 20.

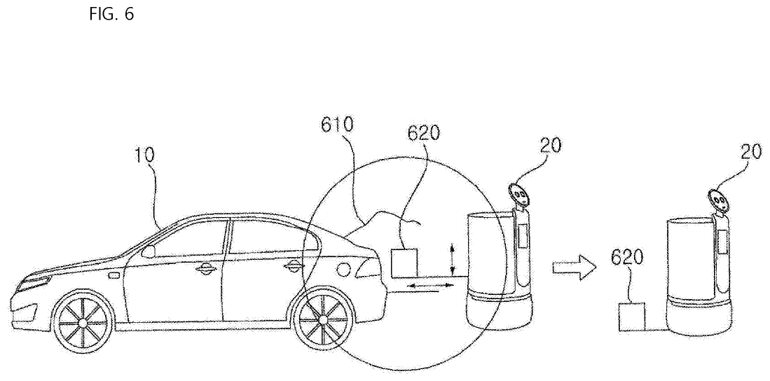

FIGS. 6 to 11 are views referred to for explanation of operation of the electronic device according to an embodiment of the present invention. In the following description, it may be understood that operation of the electronic device is executed in the processor 470, unless expressly stated otherwise.

Referring to FIG. 6, the electronic device 400 may prevent interference between the vehicle 10 and the robot 20. The electronic device 400 may perform cooperative control between the vehicle 10 and the robot 20. For example, in a parked state of the vehicle 10, the electronic device 400 may perform cooperative control to enable the robot 20 to guide the user of the vehicle 10 to a destination or to carry a burden to the destination. The vehicle 10 may be parked at an entrance of a building or a parking place. Parking operation of the vehicle 10 may be executed based on a signal generated from the electronic device 400. In a parked state, a trunk 610 of the vehicle 109 may be opened. The robot 20 may retrieve a burden 620 from the trunk 610. The robot 20 may carry the burden 620 to the destination of the user. Operation of the robot 20 to retrieve the burden 620 or to carry the burden 620 may be executed based on a signal generated from the electronic device 400.

The vehicle 10 may be an unmanned autonomous vehicle, a user-occupied autonomous vehicle, or a non-autonomous vehicle.

The user may be a mobility impaired person. The mobility impaired person may be at least one of an old man, a child, a disabled person or a pregnant woman.

The robot 20 may be a mobile robot. The robot 20 may perform at least one function of way guidance, burden carriage, burden unloading, or wheel-chair conveyance. The way guidance may be implemented through at least one of voice guidance, map guidance, light projection guidance, or accident prevention.

The space where the vehicle 10 is parked (for example, a predetermined area) may be at least one of an underground parking place, a ground parking place, a rooftop parking place, or a temporary parking place (for example, a playground).

The destination of the user may be at least one of a hotel, a resort, a supermarket, an airport, or an apartment complex.

The situation exhibiting high congestion may be at least one of rush hour or an event period. The event may be one of sports, shopping (in a mega-sale period such as Black Friday), a sky/board season, and a water park. In a situation in which both an unmanned vehicle and a manual autonomous vehicle travel, the robot 20 may perform traffic guidance.

In the case of a manual autonomous vehicle, the robot 20 may perform guidance of a parking position, and may provide additional services.

The priority order of robots may be determined in an order of a guide robot, a burden unloading robot, and a burden carrying robot. Upon lack of a guide robot, a burden carrying robot may preferentially perform guidance in a state of temporarily stopping burden carriage to a final destination, and may then perform a carriage task.

Position identification, surrounding environment recognition, path creation, control, authentication (subscriber identification), etc. may be carried out based on a signal, information or data received from at least one of the vehicle 10 or the robot 20.

The vehicle 10 may be recognized through a camera installed at an entrance of a parking place or a camera installed at the robot 20. Interaction between the vehicle 10 and the robot 20 may be achieved by wiper operation control and operation control for at least one lamp.

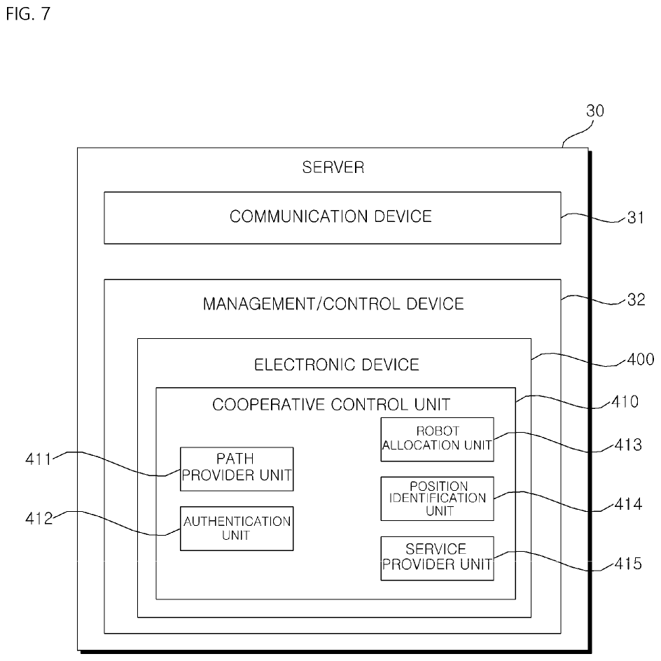

Referring to FIG. 7, the server 30 may include the communication device 31 and the management/control device 32. The communication device 31 may exchange a signal information or data with at least one of the vehicle 10, the robot 20 or the user terminal 40.

The management/control device 31 may manage and control at least one of the vehicle 10 or the robot 20. The management/control device 32 may include the electronic device 400. The electronic device 400 may refer to the description given in conjunction with FIGS. 1 to 6. The electronic device 400 may include a cooperative control unit 410. The cooperative control unit 410 may perform cooperative control between the vehicle 10 and the robot 20. Meanwhile the cooperative control unit 410 may be classified into a lower-level configuration of the processor 470. The cooperative control unit 410 may be implemented through software installed in the processor 470. The cooperative control unit 410 may be implemented through hardware (for example, a processor) in which software implementing cooperative control is installed.

The cooperative control unit 410 may include a path provider unit 411, an authentication unit 412, a robot allocation unit 413, a position identification unit 414, and a service provider unit 415. The path provider unit 411, the authentication unit 412, the robot allocation unit 413, the position identification unit 414, and the service provider unit 415 may be implemented through software blocks installed in the processor 470, respectively. The path provider unit 411, the authentication unit 412, the robot allocation unit 413, the position identification unit 414, and the service provider unit 415 may be implemented through hardware (for example, processors in which software blocks are installed, respectively.

The path provider unit 411 may provide a path of at least one of the vehicle 10 or the robot 20. The authentication unit 412 may perform authentication between the vehicle 10 and the robot 20. The robot allocation unit 413 may allocate the robot 20 matched with the vehicle 10 or the user of the vehicle 10. The position identification unit 414 may identify a position of at least one of the vehicle 10 or the robot 20. The service provider unit 415 may provide various services using the vehicle 10 and the robot 20 to the user. The services may be at least one of way guidance, burden unloading, burden carriage, or a path provision.

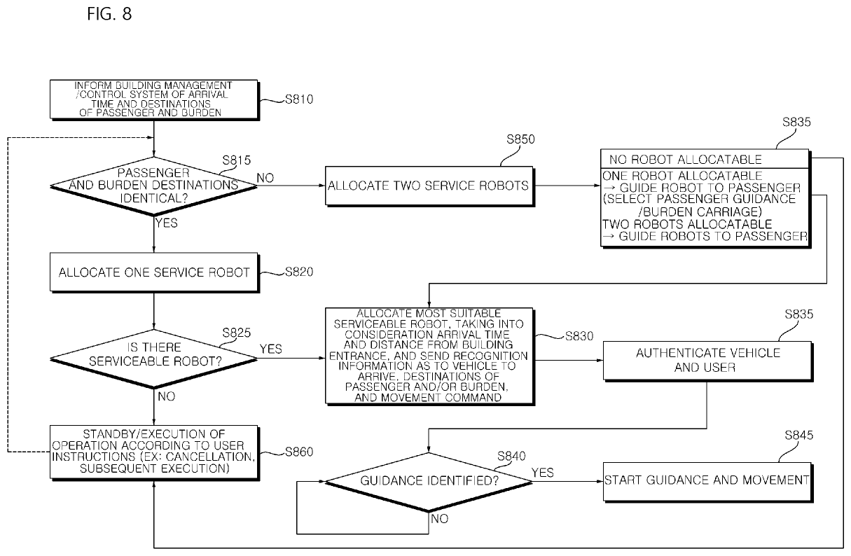

FIG. 8 illustrates a flowchart associated with the case in which the management/control unit 32 may be informed of passenger information and vehicle information. In FIG. 8, it is assumed that the passenger exits the vehicle at a building entrance, and the robot has no burden unloading function.

Referring to FIG. 8, the electronic device 400 may receive vehicle state information (S810). The electronic device 400 may receive at least one of entrance information of the vehicle 10, arrival time information of the vehicle 10, passenger information, passenger destination information, or burden destination information from the vehicle 10 or a management/control system in a predetermined area.

The electronic device 400 may determine whether or not the destination of the passenger and the destination of the burden occupied by the passenger are identical (S815). The electronic device 400 may receive destination information of the passenger and destination information of the burden from the vehicle 10, thereby determining whether or not the destinations are identical.

When the destinations of the passenger and the burden are identical, the electronic device 400 may allocate one service robot 20 (S820).

The electronic device 400 may determine whether or not there is a serviceable robot (S825).

Upon determining that there is a serviceable robot, the electronic device 400 may allocate a most suitable service robot based on an arrival time and a distance from a building entrance, may provide recognition information of the vehicle 10 to the allocated robot, may provide destination information of the passenger and the burden, and may send a movement command (S830), The electronic device 400 may authenticate the vehicle 10 and the user (S835).

The electronic device 400 may check whether or not guidance is required (S840), and may then control the service robot 20 to start guidance and movement (S845).

On the other hand, upon determining, in step S825, that there is no serviceable robot, the electronic device 400 may stand by or may receive user instructions. For example, in accordance with user instructions, the electronic device 400 may cancel provision of a service robot or may perform control for subsequent execution of provision of a service robot. When the electronic device stands by or performs the subsequent execution, the electronic device 400 may return to step S815.

On the other hand, upon determining, in step S815, that the destination of the passenger and the destination of the burden are not identical, the electronic device 400 may allocate two service robots (S850). When there is no usable service robot, the electronic device 400 may proceed to a step S860. When the number of usable service robots is one, the electronic device 400 may allocate one service robot to the passenger, and may then execute operation of step S830 and operations following step S830. The passenger may select one of a guidance service and a burden movement service using the service robot. When the number of usable service robots is two, the electronic device 400 may allocate two service robots to the passenger, and may then execute operation of step S830 and operations following step S830.

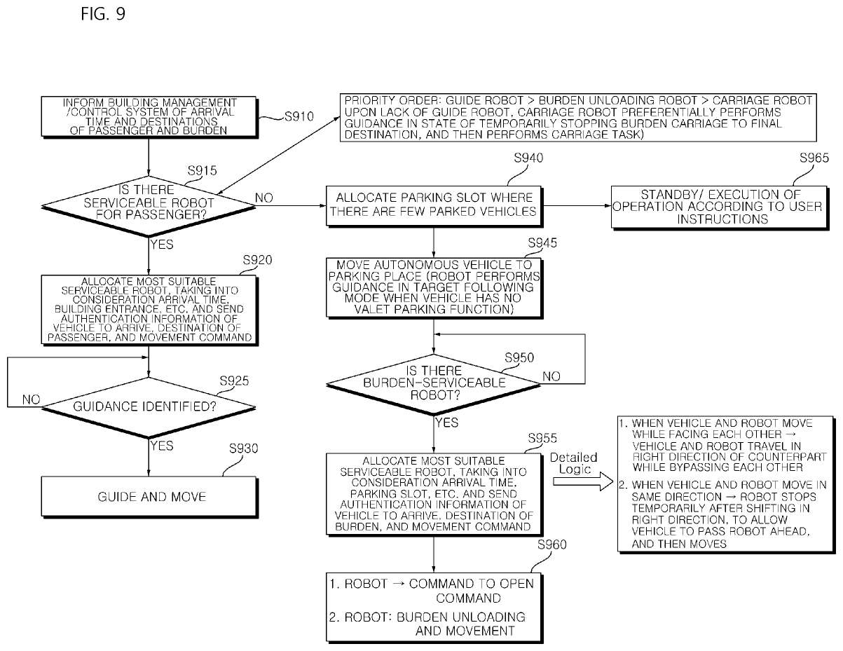

FIG. 9 illustrates a flowchart associated with the case in which the management/control unit 32 may be informed of passenger information and vehicle information. In FIG. 9, it is assumed that the passenger exits the vehicle at a building entrance, and the robot has a burden unloading function.

Referring to FIG. 9, the electronic device 400 may receive vehicle state information (S910). The electronic device 400 may receive at least one of entrance information of the vehicle 10, arrival time information of the vehicle 10, passenger information, passenger destination information, or burden destination information from the vehicle 10 or a management/control system in a predetermined area.

The electronic device 400 may determine whether or not there is a robot capable of performing a passenger service (S915). Meanwhile, the electronic device 400 may set a priority order of robots in accordance with functions. For example, a guide robot may have a higher priority than a burden unloading robot and a burden carrying robot. For example, a burden unloading robot may have a higher priority than a burden carrying robot. Upon lack of a guide robot, a burden carrying robot may preferentially perform guidance in a state of temporarily stopping burden carriage to a final destination, and may then perform a carriage task.

Upon determining that there is a serviceable robot, the electronic device 400 may allocate a most suitable service robot based on an arrival time and a distance from a building entrance, may provide recognition information of the vehicle 10 to the allocated robot, may provide destination information of the passenger and the burden, and may send a movement command (S920).

The electronic device 400 may check whether or not guidance is required (S925), and may then control the service robot 20 to start guidance and movement (S930)

Upon determining, in step S915, that there is no serviceable robot, the electronic device 400 may allocate a parking slot where there are few parked vehicles (S940).

The electronic device 400 may guide the vehicle 10 to move a parking place (S945). If the vehicle 10 has no automatic parking function, the electronic device 400 may control the robot 20 to guide the vehicle 10 to the parking place.

The electronic device 400 may determine whether or not there is a robot capable of performing a burden carrying service (S950).

Upon determining that there is a robot capable of performing a burden carrying service, the electronic device 400 may allocate a most suitable service robot based on an arrival time and a distance from a building entrance, may provide recognition information of the vehicle 10 to the allocated robot, may provide destination information of the passenger and the burden, and may send a movement command (S955). When the vehicle 10 and the robot 20 move while facing each other, the electronic device 400 may control the vehicle 10 and the robot 20 to travel in a right direction of the counterpart while bypassing each other. When the vehicle 10 and the robot 20 move in the same direction, the electronic device 400 may control the vehicle 10 and the robot 20 in such a manner that the robot 20 stops temporarily after shifting in a right direction, to allow the vehicle 10 to pass the robot 20 ahead, and then moves.

The electronic device 400 may perform control to open the trunk of the vehicle 10, to unload a burden, and to carry the burden (S960).

Meanwhile, after step S940, the electronic device 400 may control the robot 20 to stand by and then to operate in accordance with instructions from the user (S965).

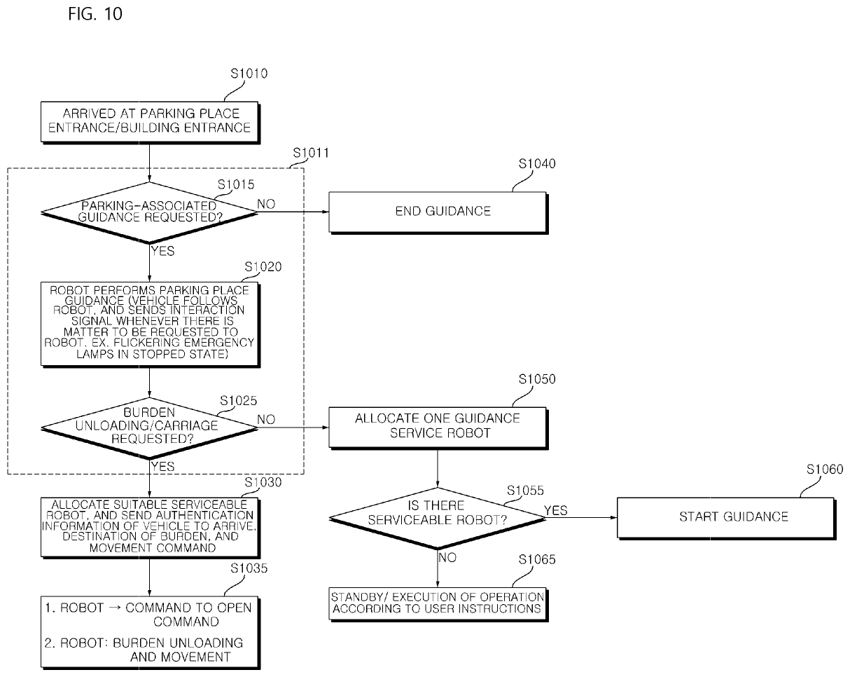

FIG. 10 illustrates a flowchart associated with the case in which the management/control device 32 cannot be informed of passenger information and vehicle information. For example, in FIG. 10, it is assumed that the vehicle is not an autonomous vehicle, but a manual vehicle, or there is a system error in an autonomous vehicle. In an embodiment of FIG. 10, the electronic device 400 may receive a predetermined analog signal of the vehicle 10 from the robot 20, and may control the robot 20 in accordance with an analog signal.

Referring to FIG. 10, after arriving at a parking place entrance or a building entrance (S1010), the vehicle 10 may co-operate with the robot 20 through the analog signal (S1011). For example, the vehicle 10 may co-operate with the robot 20 using emergency light flickering, wiper turn-on/off, turn signal on/off, etc.

When the vehicle 109 requests parking-associated guidance (S1015), the electronic device 400 may control the robot to perform parking guidance (S1020). The electronic device 400 may receive an analog signal of the vehicle 10 from the robot 20, and may perform control to provide a robot service corresponding to the analog signal. The vehicle 10 may perform parking in accordance with guidance of the robot 20. When the vehicle has a matter to be requested to the robot 20, the vehicle 10 may generate an analog signal. For example, the vehicle 10 may flicker emergency lamps in a state of stopping a travel.

When the vehicle 10 does not request parking-associated guidance (S1015), the electronic device 400 may end guidance (S1040).

When the vehicle 10 requests burden unloading and carriage (S1025), the electronic device 400 may allocate a most suitable service robot, may provide recognition information of the vehicle 10 to the allocated robot, may provide destination information of the passenger and the burden, and may send a movement command (S1030).

The electronic device 400 may perform control to open the trunk of the vehicle 10, to unload a burden, and to carry the burden (S1035).

When the vehicle 10 does not request burden unloading and carriage (S1025), the electronic device 400 may allocate one guide service robot (S1050).

The electronic device 400 may determine where or not there is a serviceable robot (S1055). When there is a serviceable robot, the electronic device 400 may control the robot 20 to perform a guidance operation (S1060). Upon determining that there is no serviceable robot, the electronic device 400 may stand by, and may then perform control for subsequent execution of a guidance operation (S1065).

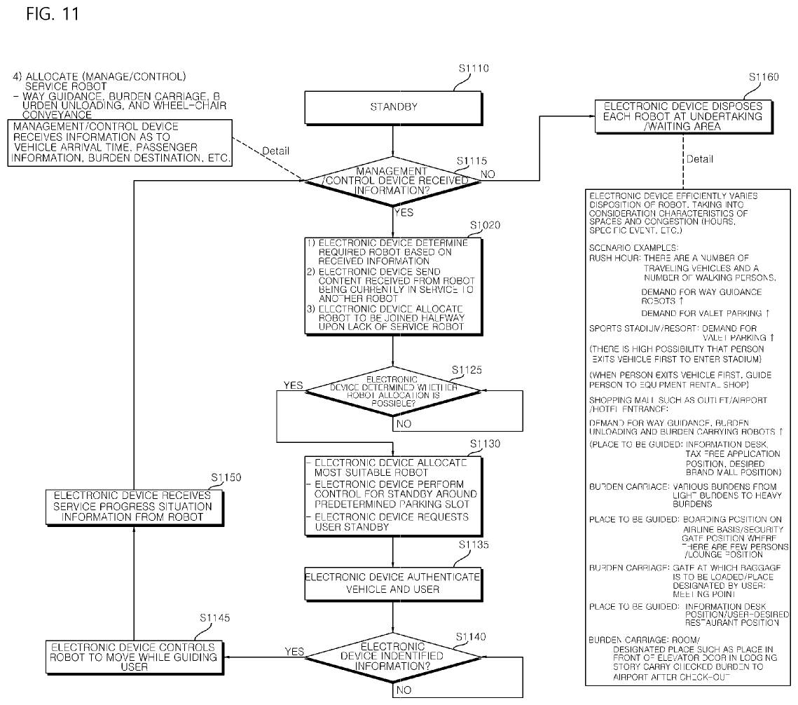

FIG. 11 illustrates a flowchart of an operation for allocating a service robot to perform functions of way guidance, burden carriage, burden unloading, wheel-chair conveyance, etc.

Referring to FIG. 11, in a standby state (S1110), the management/control device 32 may receive information (S1115). The management/control device 32 may receive arrival time, passenger information, burden information, and destination information of the vehicle 10 from a building management/control system. When the vehicle 10 is an autonomous vehicle, information may be received from the autonomous vehicle. When the vehicle 10 is a manual vehicle, information may be received from a building entrance.

Upon receiving information, the electronic device 400 may determine a required robot based on the received information (S1120). For example, the electronic device 400 may determine a wheel-chair robot to be a required robot based on mobility impaired person information. For example, the electronic device 400 may determine only a guide robot to be a required robot based on information as to whether or not there is a burden to be unloaded/carried.

The electronic device 400 may send content received from a robot being currently in service to another robot (S1120). The electronic device 400 may allocate a robot to be joined halfway upon lack of a service robot (S1120).

The electronic device 400 may determine whether or not robot allocation is possible (S1125). Upon determining that robot allocation is possible, the electronic device 400 may allocate a most suitable robot, may create a path of the robot 20, may provide the created path to the robot 20, and may transmit authentication information of the vehicle 10 to the robot 20 (S1130). The electronic device 400 may control the robot 20 to stand by around a predetermined parking point of the vehicle 10 (S1130). The electronic device 400 may request the user terminal 40 to perform user standby.

The electronic device 400 may authenticate the vehicle 10 and the user (S1135). The user authentication may be carried out through the user terminal 40.

Upon identifying information (S1140), the electronic device 400 may control the robot 20 to move while guiding the user (S1145).

The electronic device 400 may receive service progress situation information from the robot 20 (S1150). For example, the electronic device 400 may receive, from the robot 20, information as to a position on a path, information as to an estimated time taken for arrival at an arrival/meeting point, information as to whether or not a problem occurs during execution, execution completion information, user authentication change information, information as to whether or not a priority order is changed during execution, etc. The robot 20 may guide a service progress situation to the management/control device 32 and the user terminal 40.

On the other hand, when no information is input in step S1115, the electronic device 400 may dispose each robot 20 at an undertaking area/waiting area (S1160). The electronic device 400 may efficiently vary disposition of the robot 20, taking into consideration characteristics of spaces and congestion (hours, a specific event, etc.).

For example, during rush hour, there are a number of traveling vehicles and a number of walking persons and, as such, demand for way guidance robots may decrease, and demand for valet parking may increase. To cope with such a situation, the electronic device 400 may reduce disposition of way guidance robots while increasing disposition of valet parking robots.

For example, in a sports stadium or a resort, demand for valet parking may increase. In a sports stadium or a resort, there may be a high possibility that a person exits the vehicle first to enter the stadium. When a person exits the vehicle first in a sports stadium or a resort, it is necessary to guide the person to an equipment rental shop. In a sports stadium or a resort, the electronic device 400 may increase disposition of valet parking robots.

For example, in a shopping mall such as an outlet, an airport, or a hotel, demand for way guidance, burden unloading and burden carrying robots is great. In a shopping mall such as an outlet, an airport, or a hotel, the electronic device 400 may increase disposition of way guidance robots, burden unloading robots and burden carrying robots.

The electronic device 400 may control the robot 20 to guide the user to a guidance place. The electronic device 400 may control the robot 20 to carry a burden to a burden carriage place.

For example, in a shopping mall such as an outlet, the electronic device 400 controls a way guidance robot to guide a way to a position of a brand mall desired by the user.

For example, in a hotel, the electronic device 400 may control a way guidance robot to guide a way to an information desk.

For example, in an airport, the electronic device 400 may control a way guidance robot to guide a way to a tax free application position.

For example, in an airport, the electronic device 400 may control a way guidance robot to guide a way to a boarding position on an airline basis, a security gate position where there are few persons, a lounge position, etc.

For example, in an airport, the electronic device 400 may control a burden carrying robot to carry a burden to a gate, at which baggage is to be loaded.

For example, in a shopping mall, an airport, or a hotel, the electronic device 400 may control a burden carrying robot to carry a burden to a gate, at which baggage is to be loaded, or a place designated by the user.

Meanwhile, in accordance with an embodiment, a meeting point may be set. In this case, the electronic device 400 may control the robot to move the meeting point.

For example, in a hotel, the electronic device 400 may control a guide robot to guide a way to an information desk position or a user-desired restaurant position.

For example, in a hotel, the electronic device 400 may control a burden carrying robot to carry a burden to a room. In accordance with an embodiment, the electronic device 400 may control a burden carrying robot to carry a burden to a designated place such as a place in front of an elevator door in a lodging story. In accordance with an embodiment, the electronic device 400 may control a burden carrying robot to carry a checked burden to an airport after check-out.

Meanwhile, there are various burdens from light burdens to heavy burdens. The electronic device 400 may dispose a suitable burden unloading robot or a suitable burden carrying robot in accordance with information as to the weight of a burden.

The present invention as described above may be embodied as computer-readable code, which can, be written on a program-stored recording medium. The recording medium that can be read by a computer includes all kinds of recording media, on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc., and may include an embodiment having the form of a carrier wave (for example, transmission over the Internet). In addition, the computer may include a processor or a controller. Accordingly, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. An operating method of an electronic device comprising:
receiving, by at least one processor, a signal generated when a vehicle enters a predetermined area;
receiving, by at least one processor, a parking request signal of the vehicle; and
providing, by at least one processor, a wakeup signal of an interaction device to at least one of the vehicle or a robot interacting with the vehicle,
wherein the interaction device is a device for performing cooperative control of the vehicle and the robot.

2. The operating method of the electronic device according to claim 1, further comprising:
receiving, by at least one processor, situation information of the vehicle from the vehicle; and
providing, by at least one processor, data for interaction to at least one of the vehicle or the robot based on the situation information.

3. The operating method of the electronic device according to claim 2, wherein the situation information comprises path information of the vehicle; and
Wherein the providing data comprises:
producing, by at least one processor, data as to a path of the robot prevented from overlapping with a path of the robot, and
providing, by at least one processor, data as to the path of the robot.

4. The operating method of the electronic device according to claim 2, wherein the providing data comprises:
dividing, by at least one processor, the predetermined area into a vehicle area and a robot area in accordance with congestion of the predetermined area;
producing, by at least one processor, data as to a path of the robot along which the robot moves in the robot area without invading the vehicle area; and
providing, by at least one processor, data as to the path of the robot.

5. The operating method of the electronic device according to claim 4, wherein the providing data comprises:
determining, by at least one processor, at least one point, at which the robot is to be positioned, from the robot area; and
producing, by at least one processor, data as to a path of the robot comprises the producing data as to a path passing through the at least one point.

6. The operating method of the electronic device according to claim 2,
wherein the situation information comprises information as to a parking point of the vehicle and information as to a destination of a user of the vehicle;
wherein the providing data comprises:
producing, by at least one processor, data as to guide light for guidance from the parking point to the destination, and
providing, by at least one processor, data as to the guide light.

7. The operating method of the electronic device according to claim 6, further comprising:
receiving, by at least one processor, sensing data of the robot,
wherein the producing data as to guide light comprises producing, by at least one processor, the data as to the guide light further based on the sensing data.

8. The operating method of the electronic device according to claim 2,
wherein the situation information comprises motion information of at least one moving part included in the vehicle; and
wherein the providing data comprises:
producing, by at least one processor, data as to a motion of the robot prevented from interfering with a motion of the moving part, and
providing, by at least one processor, data as to the motion of the robot.

9. The operating method of the electronic device according to claim 2,
wherein the situation information comprises information as to a user of the vehicle; and
further comprising:
allocating, by at least one processor, at least one robot matched with the vehicle, based on the information as to the user.

10. The operating method of the electronic device according to claim 9,
wherein the information as to the user comprises information as to a burden occupied by the user;
wherein the allocating at least one robot comprises allocating, by at least one processor, a first robot for guiding the user and a second robot for carrying the burden by matching the first robot and the second robot with the vehicle.

11. The operating method of the electronic device according to claim 2,
Wherein the situation information comprises information as to whether the vehicle is in a manually traveling state; and
Wherein the providing data comprises:
producing, by at least one processor, data for guiding a path of the vehicle in the predetermined area, and
providing, by at least one processor, data for guiding the path of the vehicle to the robot.

12. The operating method of the electronic device according to claim 2,
Wherein the situation information comprises information as to whether the vehicle is in a manually traveling state; and
the providing data comprises providing, by at least one processor, data as to an authentication operation of the vehicle to the robot.

13. An electronic device comprising:
at least one processor configured to:
receive a signal generated when a vehicle enters a predetermined area,
receive a parking request signal of the vehicle, and
provide a wakeup signal of an interaction device to at least one of the vehicle or a robot interacting with the vehicle,
wherein the interaction device is a device for performing cooperative control of the vehicle and the robot.

14. The electronic device according to claim 13, wherein the processor is configured to:
receive situation information of the vehicle from the vehicle, and
provide data for interaction to at least one of the vehicle or the robot based on the situation information.

15. The electronic device according to claim 14, wherein the situation information comprises path information of the vehicle; and
Wherein the processor is configured to:
produce data as to a path of the robot prevented from overlapping with a path of the robot, and
provide data as to the path of the robot.

16. The electronic device according to claim 14, wherein the processor is configured to:
divide the predetermined area into a vehicle area and a robot area in accordance with congestion of the predetermined area,
produce data as to a path of the robot along which the robot moves in the robot area without invading the vehicle area, and
provide data as to the path of the robot.

17. The electronic device according to claim 16, wherein the processor is configured to:
determine at least one point, at which the robot is to be positioned, from the robot area, and
produce data as to a path passing through the at least one point.

18. The electronic device according to claim 14, wherein the situation information comprises information as to a parking point of the vehicle and information as to a destination of a user of the vehicle; and
the processor is configured to:
produce data as to guide light for guidance from the parking point to the destination, and
provide data as to the guide light.

19. The electronic device according to claim 18, wherein the processor is configured to:
receive sensing data of the robot, and
produce the data as to the guide light further based on the sensing data.

20. The electronic device according to claim 14, wherein the situation information comprises motion information of at least one moving part included in the vehicle; and
the processor is configured to:
produce data as to a motion of the robot prevented from interfering with a motion of the moving part, and
provide data as to the motion of the robot.
